(19) United States
(12) Patent Application Publication
(10) Pub. No.: US 2025/0371197 A1
(43) Pub. Date: Dec. 4, 2025

(54) Embedding Security into Ferroelectric FET Array via In-Situ Memory Operation

(71) Applicant: The Penn State Research Foundation, University Park, PA (US)

(72) Inventors: Yixin Xu, University Park, PA (US); Kai Ni, Notre Dame, IN (US); Vijaykrishnan Narayanan, University Park, PA (US); Yi Xiao, University Park, PA (US); Zijian Zhao, Notre Dame, IN (US)

(21) Appl. No.: 18/680,161

(22) Filed: May 31, 2024

(51) Int. Cl. G06F 21/72; G06F 21/79; H03K 19/17768

(52) U.S. Cl. CPC G06F 21/72; G06F 21/79; H03K 19/17768

(57) ABSTRACT

Embodiments method for configuring a data structure in a nonvolatile memory (NVM) module that includes at least one memory cell. Each memory cell can have two transistors coupled to each other such that a logic value is stored in a complementary manner. The method can involve encrypting the at least one memory cell by generating a cipher text (CT) by performing an XOR operation on plain text (PT) stored in the at least one memory cell, and performing the XOR operation on a corresponding key. In addition, or in the alternative, the method can involve decrypting cipher text (CT) of the at least one memory cell by applying a read voltage pattern to the two transistors, the read voltage pattern being VR/0 or 0/VR based on a key.

### FIELD OF THE INVENTION

Embodiments can relate to a lightweight memory encryption/decryption scheme that exploits in-situ memory operations with negligible overhead.

### BACKGROUND OF THE INVENTION

Non-volatile memories (NVMs) have the potential to reshape next-generation memory systems because of their promising properties of near-zero leakage power consumption, high density and non-volatility. However, NVMs also face critical security threats that exploit the non-volatile property. Compared to volatile memory, the capability of retaining data even after power down makes NVM more vulnerable. Existing solutions to address the security issues of NVMs are mainly based on Advanced Encryption Standard (AES), which incurs significant performance and power overhead.

### SUMMARY OF THE INVENTION

Embodiments disclosed herein provide for a lightweight memory encryption/decryption scheme by exploiting in-situ memory operations with negligible overhead. To validate the feasibility of the encryption/decryption scheme, device-level and array-level experiments are performed using ferroelectric field effect transistor (FeFET) as an example NVM without loss of generality. In addition, a comprehensive evaluation is performed on a 128×128 FeFET AND-type memory array in terms of area, latency, power and throughput. Compared with the AES-based scheme, the scheme disclosed herein shows ˜22.6 ×/˜14.1× increase in encryption/decryption throughput with negligible power penalty. Also discussed herein is an evaluation the performance of the disclosed scheme over the AES-based scheme when deploying different neural network workloads. The disclosed scheme yields significant latency reduction by 90% on average for encryption and decryption processes.

An exemplary embodiment can relate to a system for configuring a data structure in a nonvolatile memory module. The system can include a non-transitory memory having instructions stored thereon. The system can include a processor configured to execute the instructions to perform an operation on a nonvolatile memory (NVM) module. The NVM module can include at least one memory cell comprising two transistors coupled to each other such that a logic value is stored in a complementary manner. The operation can include encrypting the at least one memory cell by generating a cipher text (CT) by performing an XOR operation on plain text (PT) stored in the at least one memory cell, and performing the XOR operation on a corresponding key. In addition, or in the alternative, the operation can include decrypting cipher text (CT) of the at least one memory cell by applying a read voltage pattern to the two transistors, the read voltage pattern being V_{R}/0 or 0/V_{R} based on a key.

In some embodiments, the two transistors coupled to each other can be two consecutively situated transistors.

In some embodiments, the two transistors can be field-effect-transistors (FETs).

In some embodiments, the FETs can be FeFETs.

In some embodiments, the NVM module can include at least one memory block comprising plural memory cells.

In some embodiments, the NVM module can include plural memory blocks. Each memory cell within an individual memory block can be associated with a key.

In some embodiments, the plural memory cells can be arranged in an array.

In some embodiments, the plural memory cells can be arranged as an AND array, a NAND array, or a NOR array.

In some embodiments, after decrypting cipher text (CT), the processor can be configured to execute the instructions to generate plain text (PT) by sensing current when a signal representative of the key is applied to the at least one memory cell.

An exemplary embodiment can relate to a computer readable memory having instruction stored thereon that when executed by a processor will cause the processor to execute the instructions to perform an operation on a nonvolatile memory (NVM) module. The NVM module can include at least one memory cell comprising two transistors coupled to each other such that a logic value is stored in a complementary manner. The operation can include encrypting the at least one memory cell by generating a cipher text (CT) by performing an XOR operation on plain text (PT) stored in the at least one memory cell, and performing the XOR operation on a corresponding key. In addition, or in the alternative, the operation can include decrypting cipher text (CT) of the at least one memory cell by applying a read voltage pattern to the two transistors, the read voltage pattern being V_{R}/0 or 0/V_{R} based on a key.

In some embodiments, the two transistors coupled to each other can be two consecutively situated transistors.

In some embodiments, the two transistors can be field-effect-transistors (FETs).

In some embodiments, the FETs can be FeFETs.

In some embodiments, the NVM module can include at least one memory block comprising plural memory cells.

In some embodiments, the NVM module can include plural memory blocks. Each memory cell within an individual memory block can be associated with a key.

In some embodiments, the plural memory cells can be arranged in an array.

In some embodiments, the plural memory cells can be arranged as an AND array, a NAND array, or a NOR array.

In some embodiments, after decrypting cipher text (CT), the processor can be configured to execute the instructions to generate plain text (PT) by sensing current when a signal representative of the key is applied to the at least one memory cell.

An exemplary embodiment can relate to a method for configuring a data structure in a nonvolatile memory (NVM) module that includes at least one memory cell. Each memory cell can have two transistors coupled to each other such that a logic value is stored in a complementary manner. The method can involve encrypting the at least one memory cell by generating a cipher text (CT) by performing an XOR operation on plain text (PT) stored in the at least one memory cell, and performing the XOR operation on a corresponding key. In addition, or in the alternative, the method can involve decrypting cipher text (CT) of the at least one memory cell by applying a read voltage pattern to the two transistors, the read voltage pattern being V_{R}/0 or 0/V_{R} based on a key.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIGS. 1A (exemplary system block diagram), 1B (panels a, b, and c), 1C, 1D, and 1E shows exemplary applications of memory encryption techniques. More specifically, FIG. 1A shows an exemplary system block diagram, FIG. 1B shows an exemplary application to: (panel a) prevent from Stolen DIMM attacks; (panel b) ensure A1 privacy; and (panel c) implement in secure encrypted virtualization (SEV). FIG. 1C shows an exemplary application without protection, whereby NVMs become vulnerable after power down. FIG. 1D shows NVMs with AES-embedded protection which can be protected after power down but with high encryption overheads. FIG. 1E shows NVMs protected by an embodiment of the disclosed encryption scheme, whereby NVMs can be protected after power down with minimal penalty.

FIGS. 2A, 2B, and 2C show an exemplary memory encryption scheme, wherein FIG. 2A shows an overview of an exemplary memory encryption architecture, FIG. 2B shows three scenarios in the memory, and FIG. 2C shows details of the encryption and decryption schemes.

FIGS. 3A-3N show experimental verification results. FIGS. 3A and 3B show a TEM and schematic cross section, FIGS. 3C, 3D, 3E, and 3F show I_{D}-V_{G} characteristics for the exempalry 2FeFET memory cell, FIG. 3G shows the image of a 8×7 FeFET AND array for array-level verification, FIGS. 3H-3K show patterns of plaintext, keys, ciphertext, and corresponding VTH after encryption, FIGS. 3L, 3M, and 3N show in the decryption process, three conditions of applying different patterns of keys: correct keys, all-0 keys, random keys. The colorbar indicates the read current measured from each cell.

FIGS. 4A and 4B show evaluation Results, wherein FIG. 4A shows a comparison with AES-based encryption scheme, and FIG. 4B shows latency comparison on different neural network workloads.

FIG. 5 shows an exemplary encryption and decryption scheme for NAND memory arrays.

FIGS. 6A and 6B show an exemplary encryption and decryption scheme for NOR memory arrays in (FIG. 6A)) array level and (FIG. 6B) cell level.

FIG. 7 shows exemplary three steps for programming of the FeFET AND array to implement an embodiment of the encryption scheme.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

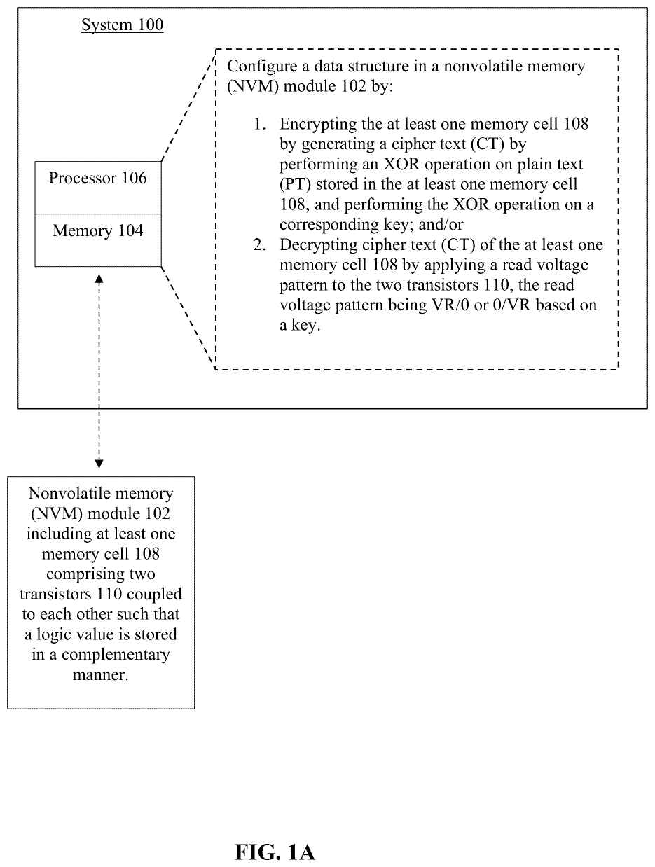

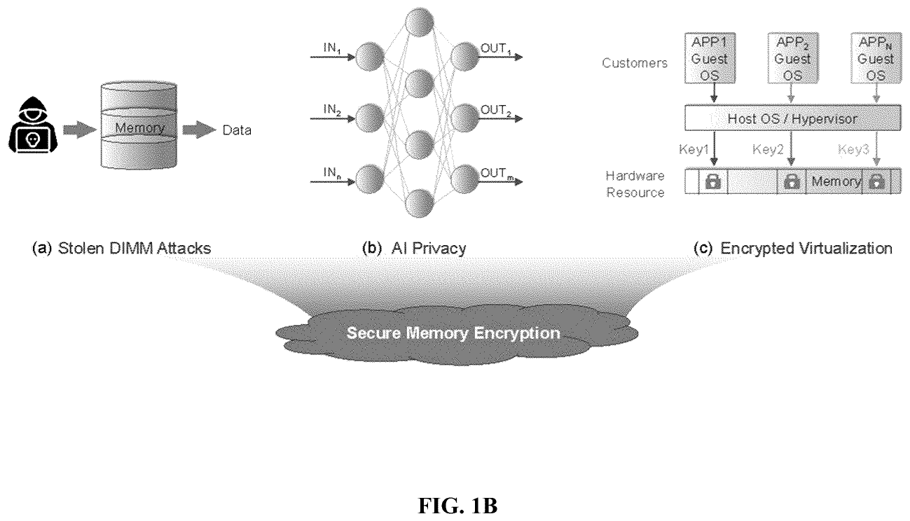

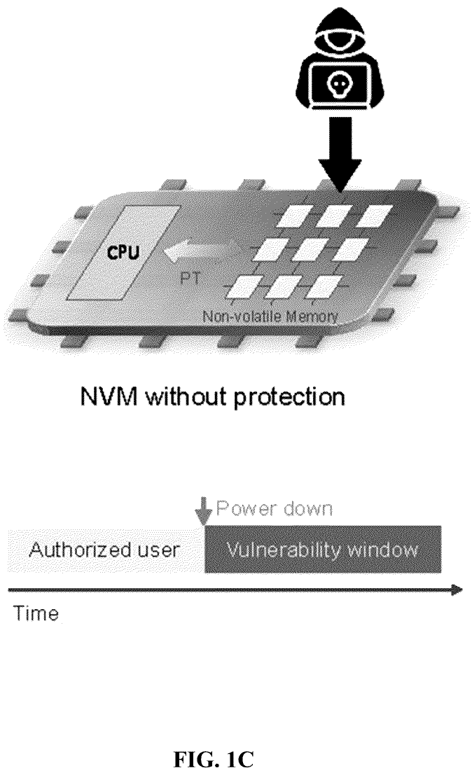

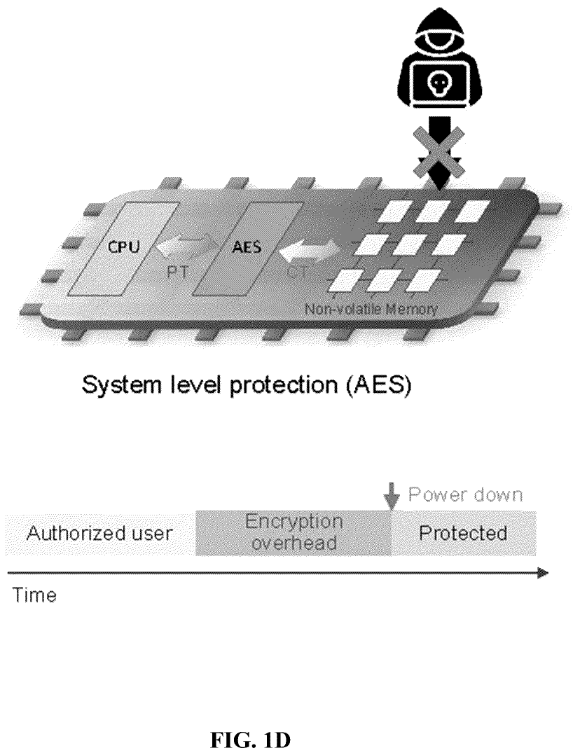

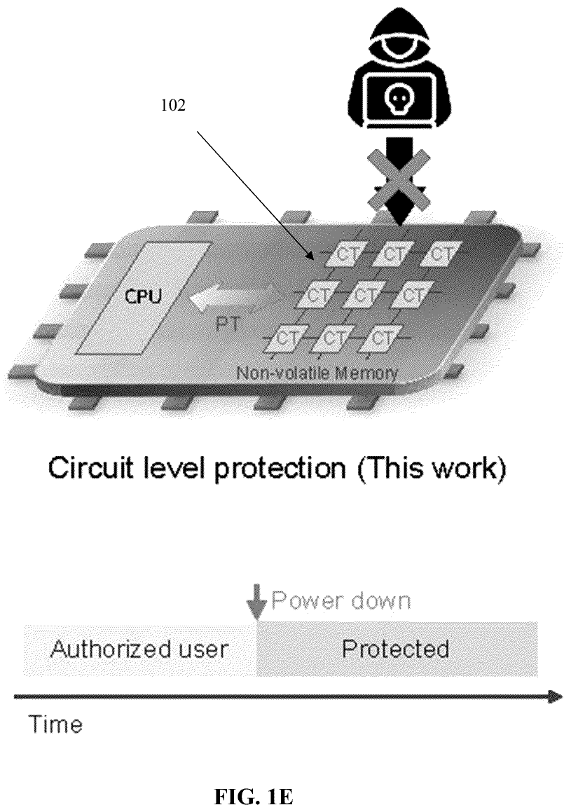

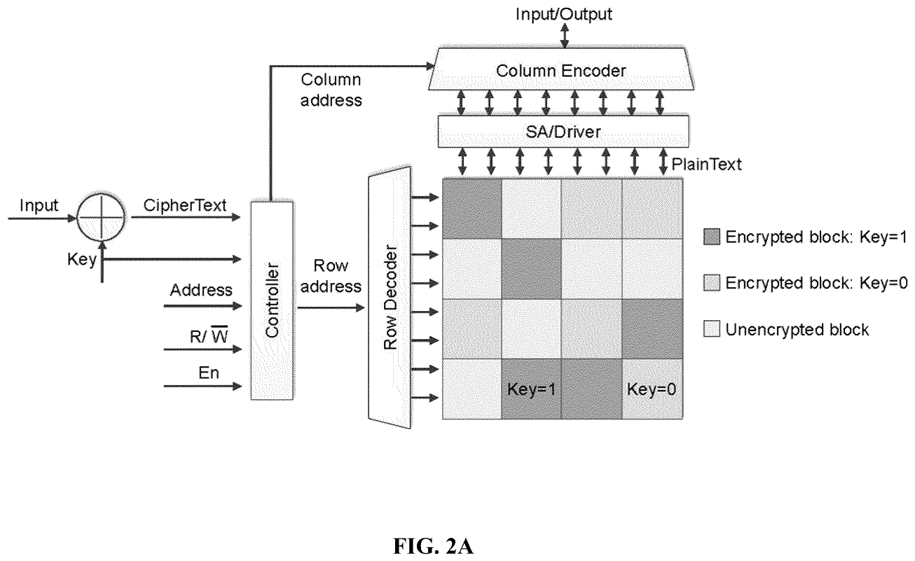

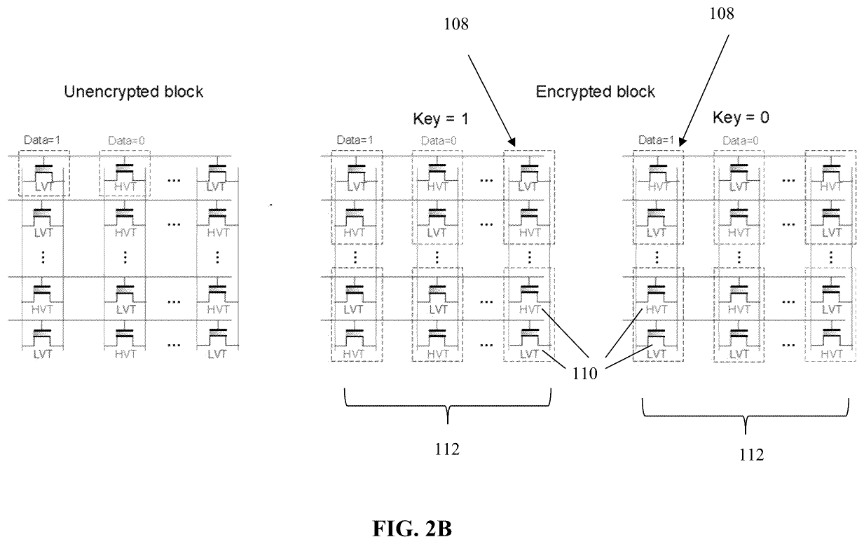

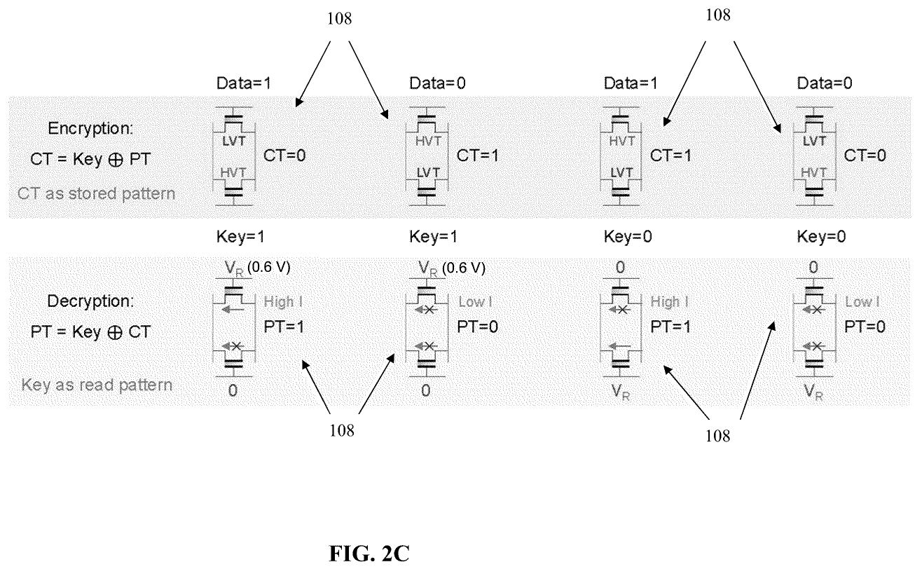

Referring to FIGS. 1-2, an exemplary embodiment can relate to a system 100 for configuring a data structure in a nonvolatile memory module 102 (e.g., read-only memory (ROM), EPROM (erasable programmable ROM) and EEPROM (electrically erasable programmable ROM), etc.). The nonvolatile memory module 102 can be embodied as one or more computer data storage devices (e.g. disk storage, hard disk drives, optical discs, floppy disks, magnetic tape, etc.). The system 100 can include a non-transitory memory 104 having instructions stored thereon. The system 100 can include a processor 106 configured to execute the instructions to perform an operation on a nonvolatile memory (NVM) module 102.

Any of the processors 106 disclosed herein can be part of or in communication with a machine (e.g., a computer device, a logic device, a circuit, an operating module (hardware, software, and/or firmware), etc.). The processor 106 can be hardware (e.g., processor, integrated circuit, central processing unit, microprocessor, core processor, computer device, etc.), firmware, software, etc. configured to perform operations by execution of instructions embodied in computer program code, algorithms, program logic, control, logic, data processing program logic, artificial intelligence programming, machine learning programming, artificial neural network programming, automated reasoning programming, etc. The processor 106 can receive, process, and/or store data.

Any of the processors 106 disclosed herein can be a scalable processor, a parallelizable processor, a multi-thread processing processor, etc. The processor 106 can be a computer in which the processing power is selected as a function of anticipated network traffic (e.g. data flow). The processor 106 can include any integrated circuit or other electronic device (or collection of devices) capable of performing an operation on at least one instruction, which can include a Reduced Instruction Set Core (RISC) processor, a Complex Instruction Set Computer (CISC) microprocessor, a Microcontroller Unit (MCU), a CISC-based Central Processing Unit (CPU), a Digital Signal Processor (DSP), a Graphics Processing Unit (GPU), a Field Programmable Gate Array (FPGA), etc. The hardware of such devices may be integrated onto a single substrate (e.g., silicon “die”), or distributed among two or more substrates. Various functional aspects of the processor 106 may be implemented solely as software or firmware associated with the processor 106.

The processor 106 can include one or more processing or operating modules. A processing or operating module can be a software or firmware operating module configured to implement any of the functions disclosed herein. The processing or operating module can be embodied as software and stored in memory 104, the memory 104 being operatively associated with the processor 106. A processing module can be embodied as a web application, a desktop application, a console application, etc.

The processor 106 can include or be associated with a computer or machine readable medium. The computer or machine readable medium can include memory 104. Any of the memory 104 discussed herein can be computer readable memory configured to store data. The memory 104 can include a volatile or non-volatile, transitory or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor 106.

The memory 104 can be a non-transitory computer-readable medium. The term “computer-readable medium” (or “machine-readable medium”) as used herein is an extensible term that refers to any medium or any memory, that participates in providing instructions to the processor 106 for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory 104 can include a processor module and other circuitry to allow for the transfer of data to and from the memory 104, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Any of the processors 106 can be in communication with other processors of other devices (e.g., a computer device, a computer system, a laptop computer, a desktop computer, etc.). Any of the processors 106 can have transceivers or other communication devices/circuitry to facilitate transmission and reception of wireless signals. Any of the processors 106 can include an Application Programming Interface (API) as a software intermediary that allows two or more applications to talk to each other. Use of an API can allow software of the processor 106 of the system 100 to communicate with software of the processor 106 of the other device(s).

The NVM module 102 can include at least one memory cell 108 (e.g., an electronic circuit that stores one bit of binary information via a logic scheme in which it stores a logic 1 via a high voltage level and can be reset to store a logic 0 via a low voltage level) comprising two transistors 110 coupled to each other such that a logic value is stored in a complementary manner. Coupling transistors 110 can involve coupling transistors 110 that are arranged in consecutive order. Thus, it is contemplated for the two transistors 110 coupled in a memory cell 108 to be two consecutively situated transistors 110. While it is contemplated for each memory cell 108 to consist of two transistors 110, it is understood that one or more memory cells 108 can have more or less than two transistors 110. Additionally, while it is contemplated for each memory cell 108 to have at least two transistors 110 coupled to each other, there may be more transistors 110 in each memory cell 108 that are coupled to each other.

The system 100 can be used to encrypted data, decrypted data, or both. For instance, the processor 106 can be a processor 106 of a device that encrypts the data, saves it to the NVM module 102, wherein the encrypted data of the NVM module 102 is decrypted by the same processor 106, a different processor 106 of the same device, or a different processor 106 of a different device. Thus, the operation of the processor 106 can include encrypting the at least one memory cell 108 by generating a cipher text (CT). This can be done by performing an XOR operation on plain text (PT) stored in the at least one memory cell 108 while also performing the same XOR operation on a corresponding key (e.g., a string of characters that changes data to make it appear random). In addition, or in the alternative, the operation can include decrypting cipher text (CT) of the at least one memory cell 108 by applying a read voltage pattern to the two transistors (e.g., the two coupled transistors) 110, the read voltage pattern being V_{R}/0 or 0/V_{R} based on a key.

Any of the transistors 110 can be a bipolar junction transistor, a Schottky transistor, a NPN transistor, a PNP transistor, a field effect transistor (FET), a metal-oxide-semiconductor field-effect transistor (MOSFET), a junction field effect transistor (JFET), etc. Exemplary embodiments describe each transistor 110 as being a FET, and more specifically an FeFET.

One or more of the NVM modules 102 can be configured as one or more memory blocks 112—e.g., a NVM module 102 can include at least one memory block 112. A memory block 112 includes plural memory cells 108. It is contemplated for each memory block 112 to include one or more arrays of memory cells 108. One or more of the arrays can be configured to operate as an AND array, a NAND array, a NOR array, etc.—e.g., the plural memory cells 108 can be arranged as an AND array, a NAND array, a NOR array, etc. It is contemplated for each memory cell 108 within an individual memory block 112 to be associated with (associated with can mean assigned, encoded with, tagged with, etc.) a key. This can include each memory cell 108 of a given memory block 112 being associated with the same key.

As indicated above, after encryption, a decryption operation can be performed. This can be done by the same processor 106 or by a different processor 106. After decrypting cipher text (CT), the processor 106 can be configured to execute the instructions to generate plain text (PT). This can be achieved by sensing current (e.g., via a sensor, a switch, etc.) that is generated when a signal representative of the key is applied to the at least one memory cell 108.

Additional embodiments can relate to a computer readable memory 104 having instruction stored thereon that when executed by a processor 106 will cause the processor 106 to execute the instructions to perform an operation on a nonvolatile memory (NVM) module 102. Again, the NVM module 102 can include at least one memory cell 108 having two transistors 110 coupled to each other such that a logic value is stored in a complementary manner. The operation can include encrypting the at least one memory cell 108 by generating a cipher text (CT) by performing an XOR operation on plain text (PT) stored in the at least one memory cell 108, and performing the XOR operation on a corresponding key. In addition, or in the alternative, the operation can include decrypting cipher text (CT) of the at least one memory cell 108 by applying a read voltage pattern to the two transistors, the read voltage pattern being V_{R}/0 or 0/V_{R} based on a key.

Additional embodiments can relate to a method for configuring a data structure in a nonvolatile memory (NVM) module 102 that includes at least one memory cell 108. Each memory cell 108 can have two transistors 110 coupled to each other such that a logic value is stored in a complementary manner. The method can involve encrypting the at least one memory cell 108 by generating a cipher text (CT) by performing an XOR operation on plain text (PT) stored in the at least one memory cell 108, and performing the XOR operation on a corresponding key. In addition, or in the alternative, the method can involve decrypting cipher text (CT) of the at least one memory cell 108 by applying a read voltage pattern to the two transistors, the read voltage pattern being V_{R}/0 or 0/V_{R} based on a key.

### EXAMPLES

The following examples include exemplary implementations and test results of embodiments disclosed herein.

FIGS. 1B (panels a, b, and c), 1C, 1D, and 1E show exemplary applications of memory encryption techniques. FIG. 1B shows an exemplary application to: (panel a) prevent from Stolen DIMM attacks; (panel b) ensure Al privacy; and (panel c) implement in secure encrypted virtualization (SEV). FIG. 1C shows an exemplary application without protection, whereby NVMs become vulnerable after power down. FIG. 1D shows NVMs with AES-embedded protection which can be protected after power down but with high encryption overheads. FIG. 1E shows NVMs protected by an embodiment of the disclosed encryption scheme, whereby NVMs can be protected after power down with minimal penalty.

The proliferation of smart edge devices has led to a massive influx of data, necessitating high-capacity and energy-efficient memory solutions for storage and processing. Traditional volatile memories, such as static random access memory (SRAM) and dynamic RAM (DRAM), are struggling to meet the demands due to their significant leakage power and low density. To address this issue, high-density NVMs, such as mainstream vertical NAND flash, has become the cornerstone of modern massive information storage. NVM offers nonvolatility, zero leakage power consumption, and high density if integrated into dense 3D form. Various emerging NVM technologies are being pursued targeting different levels of the memory hierarchy, e.g., as storage class memory or even as on-chip last-level cache, including 3D XPoint based on phase change memory (PCM), sequential or vertical 3D resistive memory, and back-end-of-line ferroelectric memory. Beyond simple data storage, NVM is playing an increasingly important role in data-centric computing, particularly in the compute-in-memory (CiM) paradigm. Within this paradigm, computation takes place in the analog domain within the memory array, eliminating the energy and latency associated with data transfer in conventional computing hardware. This has the potential to pave the way for sustainable data-intensive applications, particularly in the field of artificial intelligence, which is rapidly advancing with exponentially growing models. Hence, it is anticipated that NVM will be a crucial electronic component for ensuring sustainable computing in the future.

However, the nonvolatility of NVM also brings many new security challenges and concerns that were absent in conventional volatile memories. One of the major threats occurs when a NVM is stolen or lost, the malicious attackers may exploit the unique properties of NVM to get unauthorized accesses by low-cost tampering and then easily extract all the sensitive information stored in the devices, such as users' passwords and credit card numbers, out of the memory, and is also known as the “stolen memory attack”. Compared to volatile memory such as SRAM which is considered safe due to the loss of data after power down, NVM retains data indefinitely, making them vulnerable after the system is powered down. Besides, with the increasing demand of intensive computation and the stronger desire of large data capacity, replacing some parts of storage systems with NVMs increases the incentive to attack the system and makes more data vulnerable. Hence, the security vulnerability of NVM has become a critical issue for information-sensitive systems.

To address the above issue and ensure data security in modern NVM systems, data encryption is the most common approach. AES is the most common and widely-used cryptographic algorithm. It is a symmetrical block cipher algorithm including two processes-encryption and decryption, which converts the plaintext (PT) to the ciphertext (CT) and converts back by using 128-, 192-, or 256-bits keys. Because of the high security and high computation efficiency it provides, AES algorithm has attracted many researchers to actively explore its related hardware implementations and applications in a wide range of fields, such as wireless communication, financial transactions etc. In addition, a variety of AES-based encryption techniques were proposed aiming to address the aforementioned NVM security issues and improve the security of NVM. However, AES encryption and decryption incurs significant performance and energy cost due to extra complexity involved with read and write operations. An incremental encryption scheme, called as i-NVMM, was proposed to reduce the latency overhead, in which different data in NVMs is encrypted at different times depending on what data is predicted to be useful to the processor. By doing partial encryption incrementally, i-NVMM can keep the majority of memory encrypted while incurring affordable encryption overheads. However, i-NVMM relies on the dedicated AES engine that is impacted by limited bandwidth. Other prior works have proposed near-memory and in-memory encryption techniques as solutions to address the performance issues. For instance, AIM, which refers to AES in-memory implementation, supports one in-memory AES engine that provides bulk encryption of data blocks in NVMs for mobile devices. In AIM, encryption is executed only when it's necessary and by leveraging the benefit of the in-memory computing architecture, AIM achieves high encryption efficiency but the bulk encryption limits support fine-grain protection. In summary, prior AES-based encryption schemes fail to efficiently address the aforementioned security issues in NVMs without incurring negligible costs. Embodiments of the scheme disclosed herein break the dilemma between encryption/decryption performance and cost by finding a satisfactory solution to address the security vulnerability issue. \

As will be explained herein, embodiments of the memory encryption/decryption scheme exploit the intrinsic memory array operations without incurring complex encryption/decryption circuitry overhead. The idea is to use the intrinsic memory array operations to implement a lightweight encryption/decryption technique, e.g., bit wise XOR between the secret key and the plaintext/ciphertext, respectively. In this way, the ciphertext is written into memory through normal memory write operations and the data is secure unless a correct key, which attackers do not possess, is provided during the memory sensing operation.

This work demonstrates this proposed encryption/decryption operation in FeFET memories and can be extended to other NVM technologies. Ferroelectric HfO₂ has revived interests in ferroelectric memory for its scalability, CMOS compatibility, and energy efficiency. Inserting the ferroelectric into the gate stack of a MOSFET, a FeFET is realized such that its threshold voltage (V_{TH}) can be programmed to the low-V_{TH}(LVT) state or high-V_{TH}(HVT) state by applying positive or negative write pulses on the gate, respectively. In this work, with the co-design from technology, circuit and architecture level, the proposed efficient encryption/decryption scheme can successfully remove the vulnerability window and achieve secure encryption in FeFET-based NVM. Moreover, since there is no additional complicated encryption/decryption engine (e.g., AES engine) as a part of the peripheral circuit in the innovative architecture, embodiments of the disclosed design can avoid the latency/power/area costs in AES-based encryption designs by only adding lightweight logic gates, which dramatically improves the performance of memory and expands the range of potential applications in different fields.

With embodiments of the memory encryption/decryption scheme integrated in FeFET memory array, many NVM-targeted attacks can be prevented. For example, if the memory device is stolen or lost, embodiments of the innovative design can effectively protect it against the malicious stolen memory attack as the attacker has no knowledge of what the data represents without correct secret keys even though they are able to physically access and read out the stored ciphertext. Besides, with negligible incurred overhead compared with normal memory, embodiments of the innovative design can benefit wide applications that can exploit the added security feature without compromising performance. For instance, NVM arrays can be used to accelerate the prevalent operation in deep neural networks, e.g., matrix vector multiplication (MVM) in memory. By storing the trained neural network weights as, for example, the NVM conductance, the intended MVM operation is naturally conducted in analog domain by applying the Input as input voltage pulses and summing up the resulting array column current. As artificial intelligence makes significant strides in various application domains, especially those information sensitive sectors, how to protect these trained weights from malicious entities becomes an essential problem. Many relevant works have explored and demonstrated that data encryption embedded in CiM enables in-situ authentication and computation with high area and energy efficiency. Compared to existing AES-based encryption design which would introduce significant delay, embodiments of the innovative encryption design can efficiently encrypt and decrypt all the weights in-situ and perform CiM computation with the encrypted weights directly thus ensuring high security and privacy Another application example is secure encrypted virtualization (SEV). SEV systems require keys to isolate guests and the host OS/hypervisor from one another in order to ensure the data security in system hardware. However, present SEV systems use AES engines for encryption. By replacing the AES engines with embodiments of the innovative design, the system performance can be improved in terms of latency. In addition, embodiments of the encryption strategy can work with AES together as well in order to provide higher security for some specific applications, such as SEV. For example, the AES can be adopted as the first cipher and the proposed design as the second cipher. During encryption, the plaintexts can first send to the AES engine to get the ciphertexts which would be sent as inputs of the XOR cipher to do the second encryption. The ciphertexts after these two ciphers can finally be stored in the FeFET arrays with improved security. Similarly, for decryption, the data in the memory can be read out using the disclosed decryption method and then sent to AES to obtain the actual plaintexts.

Overview of embodiments of the innovative memory encryption/decryption scheme.

FIGS. 2A, 2B, and 2C show an exemplary memory encryption scheme, wherein FIG. 2A shows an overview of an exemplary memory encryption architecture, FIG. 2B shows three scenarios in the memory, and FIG. 2C shows details of the encryption and decryption schemes.

For a deeper look into the design principles of embodiments of the innovative in-situ encryption/decryption scheme in FeFET array, details from different granularity and levels are demonstrated in FIGS. 2A, 2B, and 2C. FIGS. 2A shows an overview of an exemplary encryption memory architecture, including the FeFET-based memory array and the associated peripheral circuitry. In the exemplary encryption design, the whole memory is encrypted in block-wise, which means it uses one key (1/0) per block. Depending on different cost and security demands, the granularity of encrypted blocks varies. As shown in FIG. 2B, there are three situations in the memory—unencrypted blocks, encrypted blocks with key=1, and encrypted blocks with key=0. For unencrypted blocks, they operate as traditional FeFET memory array. For each memory cell, depending on which data to store (1/0), FeFET would be programmed to LVT state or HVT state by applying different write voltages (±V_{W}). However, for encrypted blocks, each memory cell has two FeFETs, thus more compact than the SRAM counterpart, as illustrated in FIG. 2B. Hence, during every write operation, two rows can be selected and asserted by different voltages (±V_{W}). In this work, a memory array shares a common body contact for high density, where a block-wise erase is performed every time a programming needs to be done. Note that bit-wise write schemes can also be adopted if single-bit programming is needed, where a column-wise body contact is adopted at the cost of memory density. The details of the programming and inhibit schemes are discussed later. In addition, with different keys, these encrypted blocks follow different encryption strategies. The details of the proposed encryption/decryption strategies are demonstrated in FIG. 2C in cell level.

In the encryption process, the key is XORed with PT to obtain the CT. And the two FeFETs in the same cell would be programmed to different state patterns depending on the data that CT represents. For example, if the PT is ‘1’ and the key for this block is ‘1’, then the CT would be ‘0’. Based on the exemplary encryption strategy, the upper FeFET in the target cell should be programmed to LVT state and the bottom one should be programmed to HVT state. Similarly, if the result of CT is ‘1’, then the upper FeFET should be set to HVT state and the bottom FeFET should be set to LVT state. In the decryption process, different read voltages (V_{R}/0 V) are applied on the gate terminals of FeFETs. However, the voltage pattern of decryption is different from that of encryption in the proposed design. The voltage pattern (V_{R}/0 or 0/V_{R} ) is only relevant to the key of this cell. More specifically, if the key=1, V_{R} would be applied on the gate of the upper FeFET in the memory cell, and 0 V would be applied to the other FeFET. In contrast, if the key=0, V_{R} would be asserted on the bottom FeFET instead. In this way, original data (PT) can be successfully read out through sensing the current only when the user uses the correct key. However, for unauthorized users/attackers, even though they may have the physical access to read out the current of each memory cell, they are not aware of whether the information they read is correct or not since they do not know the correct keys for each block. Therefore, the FeFET memory are protected from information leakage and achieves intrinsic secure without extra circuit cost. Note that this design is significantly different over the SRAM based XOR encryption/decryption. In that design, decryption is performed by reading the stored SRAM information via selectively activating the access transistor connected to BL or BL⁻, which unfortunately destroys the original symmetry of the SRAM structure, making it incompatible with normal SRAM arrays. Besides, single-ended sensing requires dedicated ADCs for both BL and BL⁻ and the CiM operation requires delicate balancing of the charging and discharging paths. None of these challenges exist for embodiments of the presently disclosed design, making it highly appealing.

Embodiments of the in-situ memory encryption/decryption scheme is not just limited for the AND arrays. This work also explores and demonstrates the feasibility of embodiments of the scheme to apply in other array structures, such as FeFET NAND array which provides potentially higher integration density and FeFET NOR array. Both of them show that the embodiments of the memory encryption/decryption scheme is general and can fit into different memory designs.

Bearing the similar single transistor structure, the conventional NAND and NOR flash memories can also be encrypted/decrypted with the proposed techniques. However, flash generally require a large operation voltages and a long write latency, therefore exhibiting a poor performance compared with FeFET. In both of FeFET NAND and NOR arrays, two FeFETs are coupled as one cell for representing one bit information-bit ‘1’ or bit ‘0’. During the encryption process, firstly, CT will be determined by XORing PT and the corresponding key. Depending on different CT, complementary states will be programmed into the 2FeFET-based cell. During the decryption process, different read voltages depending on key patterns will be applied to the coupled FeFETs in the same cell. Finally, the correct information (PT) would be successfully read out.

### Experimental Verification

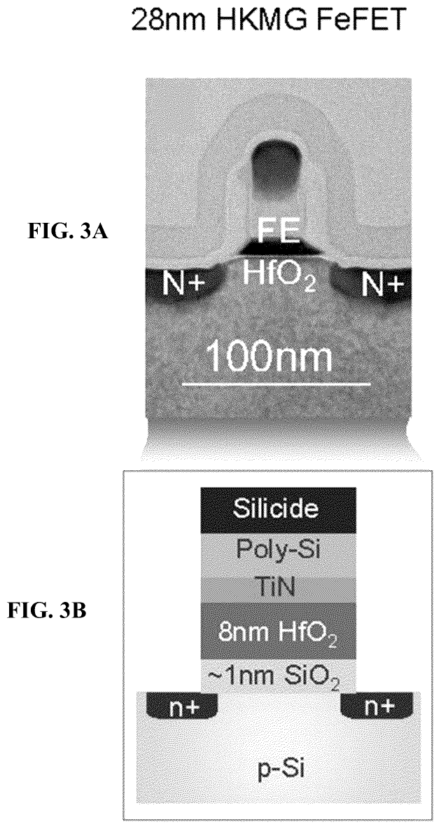

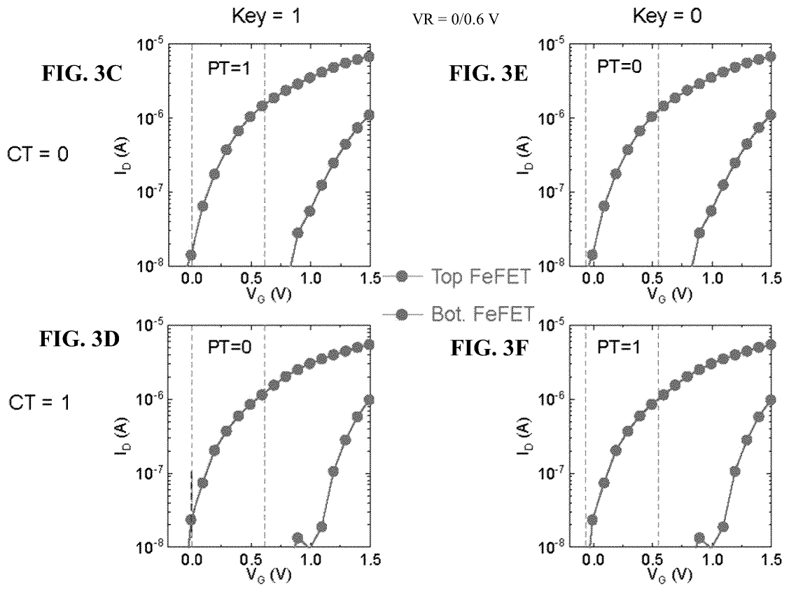

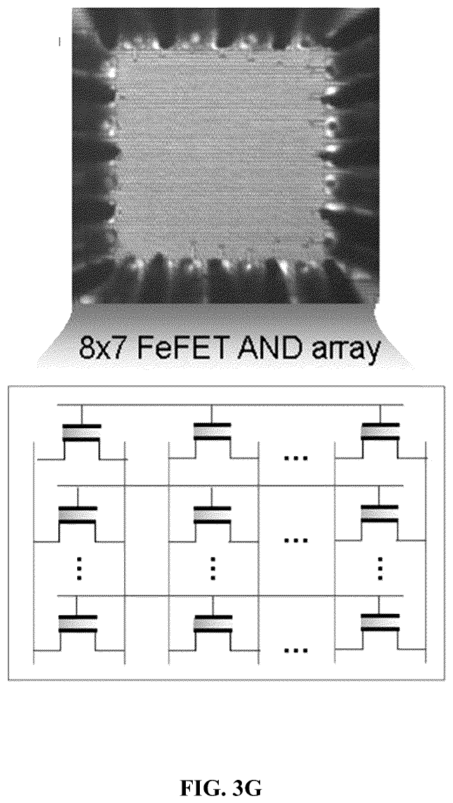

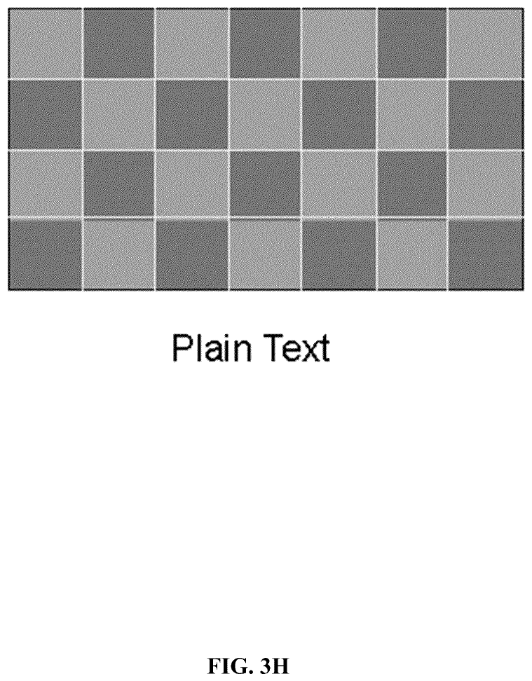

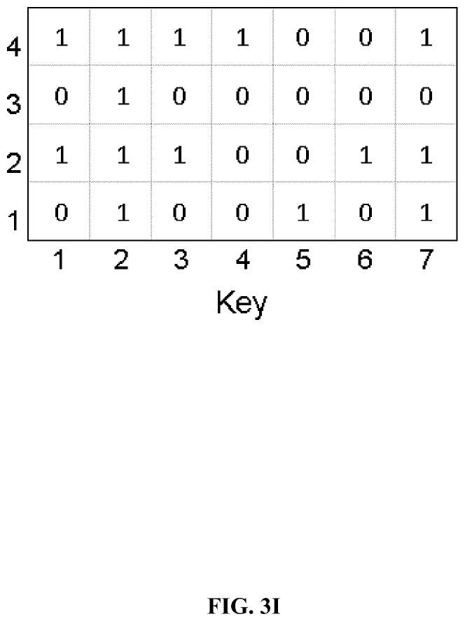

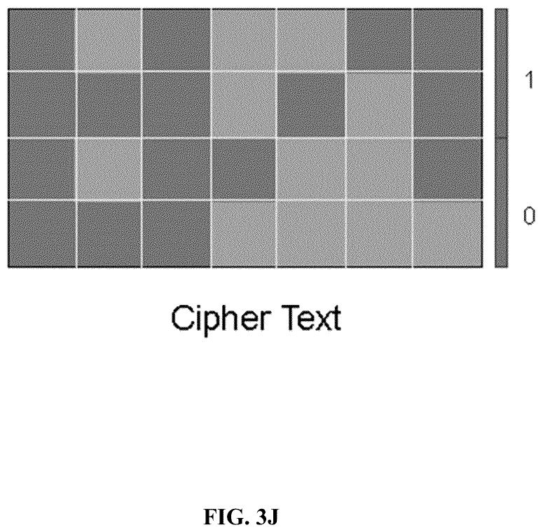

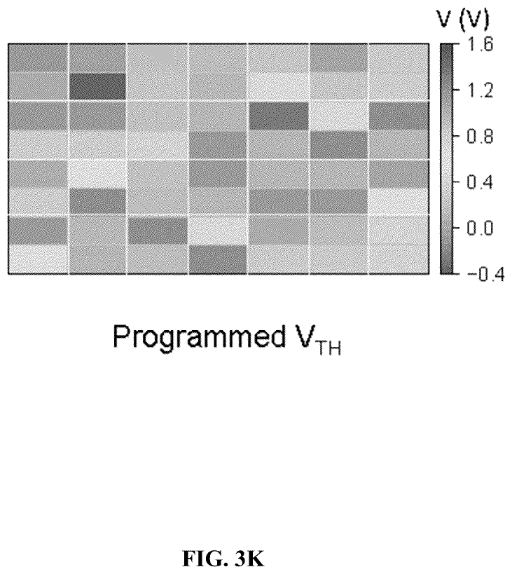

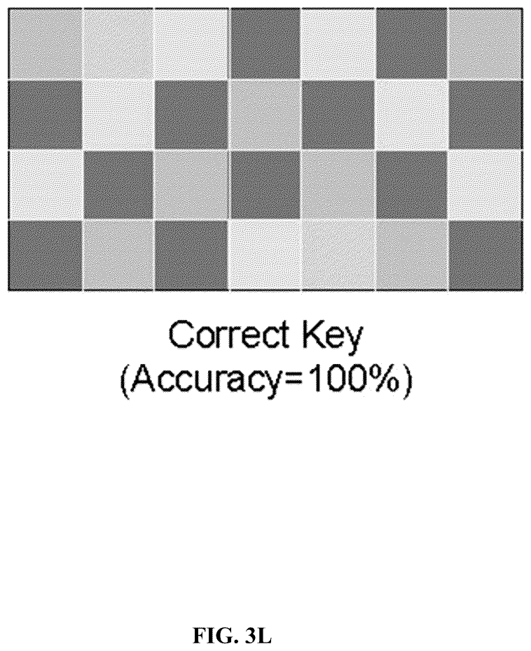

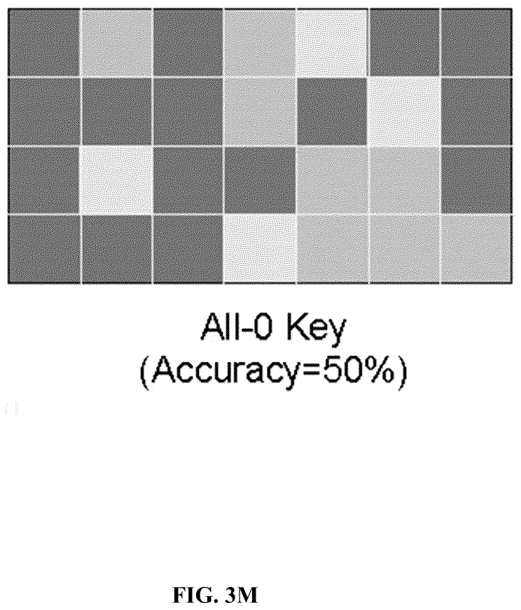

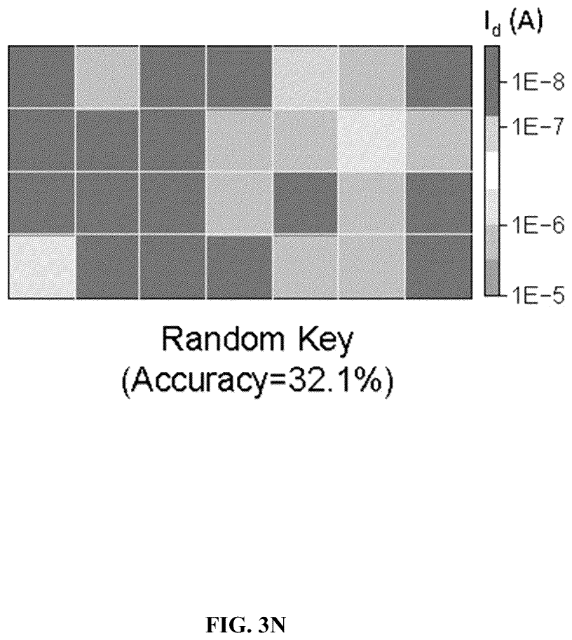

FIGS. 3A-3N show experimental verification results. FIGS. 3A and 3B show a TEM and schematic cross section, FIGS. 3C, 3D, 3E, and 3F show I_{D}-V_{G} characteristics for the exempalry 2FeFET memory cell, FIG. 3G shows the image of a 8×7 FeFET AND array for array-level verification, FIGS. 3H and 3K show patterns of plaintext, keys, ciphertext, and corresponding V_{TH} after encryption, FIGS. 3L, 3M, and 3N show in the decryption process, three conditions of applying different patterns of keys: correct keys, all-0 keys, random keys. The colorbar indicates the read current measured from each cell.

In this section, functional verification of encryption/decryption operations on one single cell and memory array is demonstrated. For experimental measurement, FeFET devices integrated on the 28 nm high-k metal gate (HKMG) technology platform are tested. FIG. 3A and 3B show the transmission electron microscopy (TEM) and schematic cross-section of the device, respectively. The device features an 8 nm thick doped HfO₂ as the ferroelectric layer and around 1 nm SiO₂ as the interlayer in the gate stack. The experimental setup for on-wafer characterization is discussed later. First single cell encryption/decryption shown in FIG. 2C is demonstrated. FIGS. 3C and 3E show the I_{D}-V_{G} characteristics of each FeFET in a cell storing the CT of bit ‘0’ for key bit of ‘1’ and ‘0’, respectively. With CT of ‘0’, the top/bottom FeFET is programmed to the LVT/HVT, using +4V/−4V, 1 μs write gate pulse, respectively. Then the decryption process simply corresponds conventional array sensing operation but with key-dependent read voltages on the two FeFETs (see the dashed line in FIGS. 3C and 3E). For example, with key of ‘1’, the top/bottom FeFETs are applied with V_{R} (i.e., 0.6V)/0V, respectively. In this way, the top FeFET contributes a high read current, thus corresponding to the PT of bit ‘1’. If the key is bit ‘0’, the read biases for the two FeFETs are swapped such that the top/bottom FeFETs receive 0V/V_{R}, respectively, where both FeFETs are cut-off, thus corresponding to the PT of bit ‘0’. Successful decryption can also be demonstrated for CT of bit ‘1’ as shown in FIGS. 3D and 3F, where the top/bottom FeFETs are programmed to the HVT/LVT state, respectively and the same key-dependent read biases are applied. These results demonstrate successful single cell decryption through sensed cell current.

Array-level experiments and functional verification are also performed and demonstrated. Without loss of generability, FeFET AND array is adopted. FIG. 3G illustrates a 8×7 FeFET AND memory array for measurements. Specifically, all the FeFETs have a W/L=0.45 μm/0.45 μm. As of now, variability in FeFET has been steadily improved. The array error rate has fallen below 10-6 for FeFET with W/L=0.2 μm/0.2 μm. Continual material and process optimization could push the scaling of memory even further. As illustrated in FIG. 3H, a checkerboard data pattern of PT (the lighter and darker boxes represent data ‘1’ and data ‘0’) and random keys shown in FIG. 3I are used. To show the most general case, bit-wise encryption/decryption is validated, as encryption at a coarser granularity, e.g., row-wise or block-wise, is simply derivation of the bit-wise case. With the PT and keys determined, the CT is simply the XOR result between the PT and corresponding keys, as shown in FIG. 3J. Each CT bit is then stored as the complementary V_{TH} states of the two FeFETs in each cell. Different write schemes along with disturb inhibition strategy can be applied. In this work, block-wise erase is performed first by raising the body potential to reset the whole array to the HVT state and then selectively programming corresponding FeFETs into the LVT state. FIG. 3K shows the V_{TH} map of 8×7 FeFETs in the array after the encryption process, corresponding to 4×7 encrypted CT.

For the decryption process, three different scenarios are considered, e.g., using correct keys, all-0 keys, and random keys. For bit-wise encryption/decryption in AND array, since all the FeFETs in the same row share the same word line, it requires two read cycles to sense the whole row. This is because the key-dependent read voltage biases are different for key bit ‘1’ and bit ‘0’. Therefore, two read cycles are required, where cycle 1 and 2 reads out the cells with key bit ‘1’ and ‘0’, respectively. Cycle 1 results are temporarily buffered and merged with cycle 2 results. Note, that the additional latency can be avoided if row-wise or block-wise encryption granularity is used, where the same word line bias can be applied. As shown in FIG. 3L, under the condition of using correct keys, the user can successfully read out all PT. For attackers without the knowledge of keys, two representative scenarios are considered, where the attackers can simply apply all-0 keys or random keys. In the condition of all-0 keys, the accuracy is only 50%, as shown in FIG. 3M. With random keys, the accuracy of decryption is only 32.1%, which is much worse than other two conditions. Above all, both the functional correctness of the proposed encryption design and the resistance against attacks are verified at the cell level and array level.

### Evaluation and Case Study

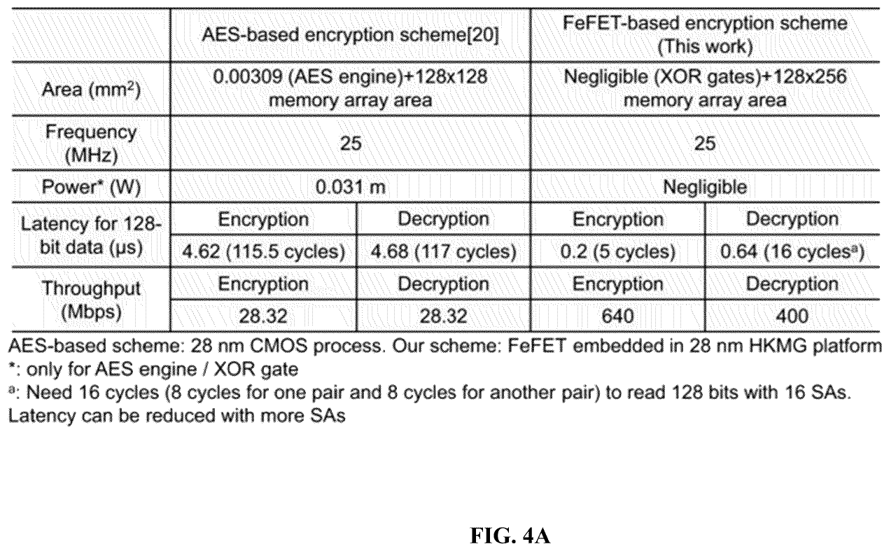

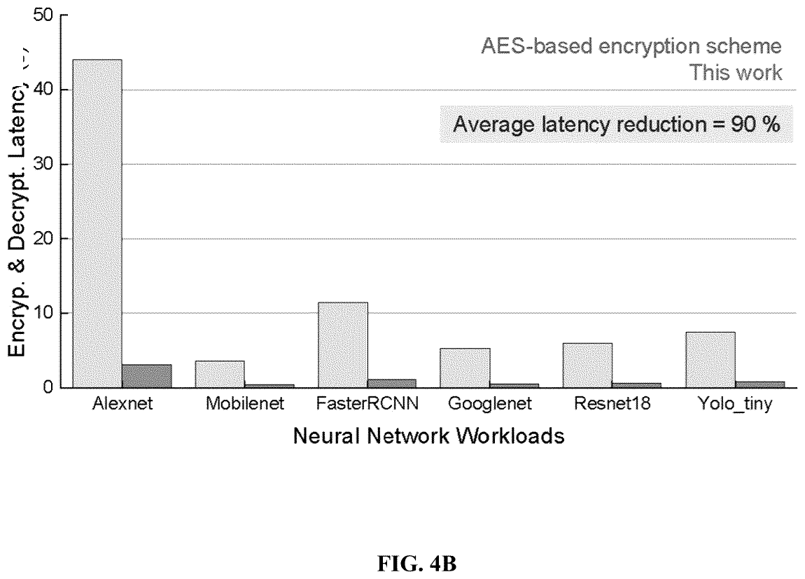

FIGS. 4A and 4B show evaluation Results, wherein FIG. 4A shows a comparison with AES-based encryption scheme, and FIG. 4B shows latency comparison on different neural network workloads.

To evaluate the feasibility and performance of embodiments of the in-situ memory encryption/decryption scheme using FeFET memory arrays, a comprehensive evaluation is performed between this work and AES-based encryption scheme in terms of area, latency, power, and throughput. For a fair comparison, an 128×128 FeFET AND-type array is designed in 28 nm HKMG platform and operates at 25 MHz, consistent with the reference AES work. This speed serves as a pessimistic estimation of FeFET array encryption/decryption operation as it can operate at a higher speed. In addition, for memory sensing, 16 sense amplifiers (SAs) are used for illustration. If a higher sensing throughput is needed, more SAs can be deployed. For the evaluation, both the AES and an exempalry in-situ encryption/decryption scheme are applied. As summarized in FIG. 4A, for the prior AES-based work, the area cost of its AES unit is 0.00309 mm². However, for embodiments of the innovative scheme, the only functional gate required is XOR gates, whose area is negligible comparing to the whole memory area cost. Note that even though the encrypted cell size is twice of the normal FeFET cell, the area overhead of memory itself may not be 2× of normal memory area. As discussed carlier, the granularity of encrypted blocks depends on the application demands and cost budgets. Therefore, if for applications that require every FeFET cell to be encrypted, then the core array area will be twice the original unencrypted array. For certain applications, it may not be necessary to encrypt the whole memory. In that case, partial encryption can be implemented while maintaining high security. For those unencrypted blocks, normal 1T cells are adopted. Therefore, the final core arca overhead will be 1×-2×. Moreover, the area overhead of the 2T structure only accounts for a very small part of the whole secure memory core, and is negligible compared with the area overhead of the AES engine. Besides, latency is one of the most important criteria for evaluating encryption methods. In the exemplary design, the encryption and decryption latency for 128-bit data are 5 cycles and 16 cycles, respectively, which is much less than the latency penalty of the AES accelerator (115.5 cycles, 117 cycles). One thing should be noticed is that decryption latency would be reduced if more SAs are used for sensing. Moreover, at the frequency of 25 MHz, the performance of 640/400 Mbps throughput is obtained during the encryption/decryption process, which is much better than that of the AES accelerator (throughput: 28.32 Mbps). Since the power consumption of our encryption circuit is only equal to that of multiple XOR gates, it is negligible compared to the AES accelerator (0.031 mW).

In addition, to investigate the latency benefit provided by the proposed scheme compared to the conventional AES scheme when implementing data encryption and decryption with different neural network (NN) workloads, a case study is performed on 6 NN workloads which are Alexnet, Mobilenet, FasterRCNN, Googlenet, Restnet 18, and Yolo_-tiny via SCALE-Sim which is a simulator for evaluating conventional neural network (CNN) accelerators. In this case study, we specifically consider this scenario—all the workloads are implemented into a systolic array for processing (Google TPU in this case). The encrypted weights of each neural network are pre-loaded into FeFET-based memory arrays for feeding to the systolic system after decryption. After the computation, the outputs will be read out and securely stored into the FeFET memory with encryption. As shown in FIG. 4B, the latency introduced by encryption and decryption processes of the proposed scheme is much less than that of AES-based scheme. The average latency reduction over these 6 workloads is ˜90%. According to the simulation results, it shows that the proposed in-situ memory encryption/decryption scheme offers significant time savings over the conventional AES scheme, especially when processing data-intensive applications, such as neural networks.

### Experimental Details

The electrical characterization was conducted using a measurement setup comprising a PXle System provided by NI. To access each contact of the testpad, a separate NI PXIe-4143 Source Measure Unit (SMU) was employed. Source selection for each contact was facilitated by a customized switch-matrix controlled by NI PXIe-6570 Pin Parametric Measurement Units (PPMU). The external resistor was connected to the source-terminal contact on the switch- matrix. The probe-card established the connection between the switch-matrix and the FeFET-structures. The measurement setup utilizes a PXI System that incorporates Source Measurement Units (SMU) and Pin Parametric Measurement Units (PPMU). The PPMUs are employed to configure the Switch Matrix, allowing the source signals to be routed to the corresponding contact needles. The test structures, present on 300 mm wafers, are connected to the measurement setup through a semi-automatic probe station, facilitated by a probe card. NAND encryption scheme.

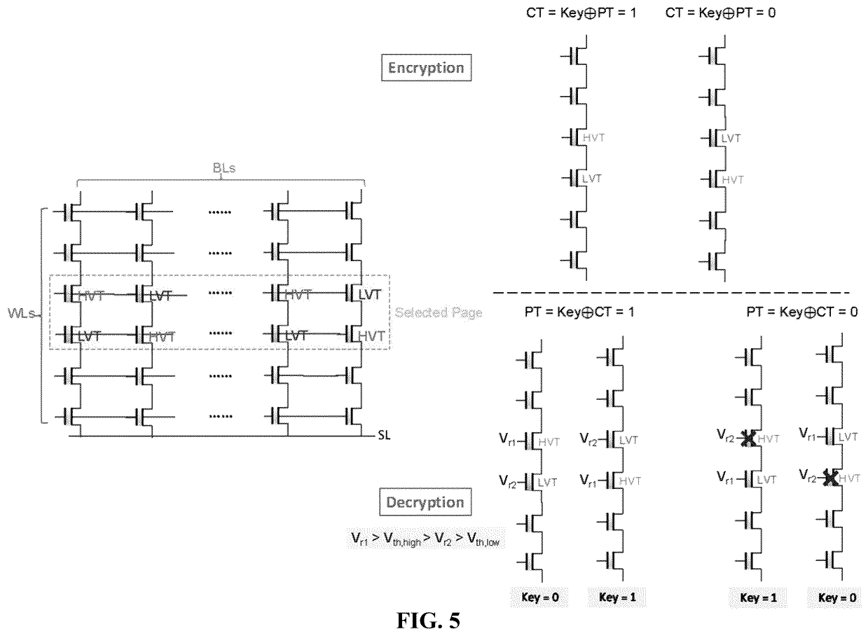

FIG. 5 shows an exemplary encryption and decryption scheme for NAND memory arrays. Besides the FeFET AND array, embodiments of the encryption scheme can be implemented in the form of FeFET NAND array which provides potentially higher integration density (shown in FIG. 5). Similar to the AND array case, 2 neighboring FeFETs are grouped as a cell to represent 1 bit stored information. For the encryption process, firstly the key is XORed with PT to obtain the CT. If CT is 1 (0), the two consecutive FeFETs on the selected NAND string are programmed to HVT and LVT (LVT and HVT) respectively. During the decryption process, two possible voltages (Vᵣ₁ and Vᵣ₂) are applied on the gate nodes of FeFETs, which satisfy Vᵣ₁>V_{th,high}>Vᵣ₂>V_{th,low} Vᵣ₁/Vᵣ₂ are applied on the first/second FeFET when Key=0, and Vᵣ₂ /Vᵣ₁ are applied on the first/second FeFET when Key=1. If PT=1, Vᵣ₁ is applied on the HVT FeFET and Vᵣ₂ is applied on the LVT FeFET, in which case they are both ON so that a high current is sensed on the NAND string. If PT-0, ᵣ₁ is applied on the LVT FeFET and Vᵣ₂ is applied on the HVT FeFET. Since the HVT FeFET is OFF, the read current is low. In this way, CT is XORed with Key so that PT is obtained by sensing the read current. NOR encryption scheme.

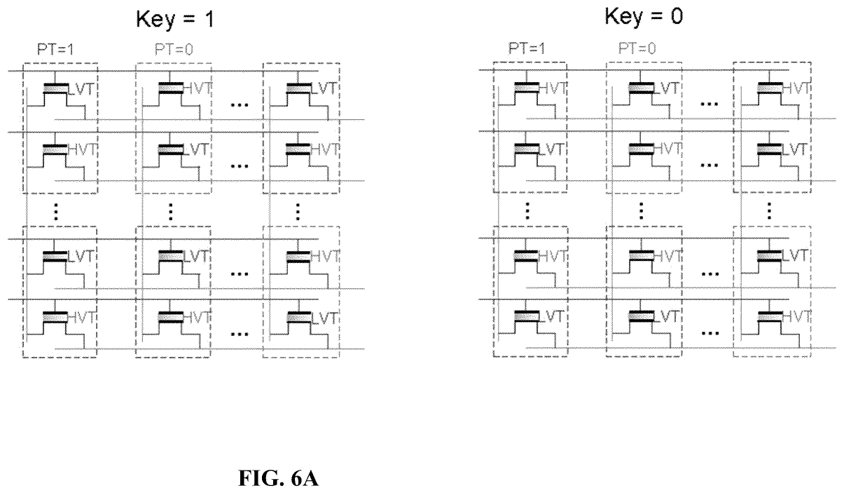

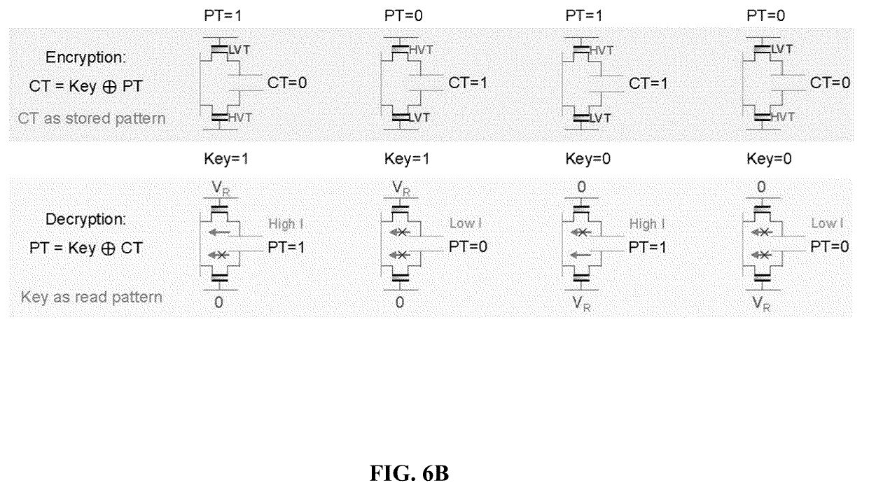

FIGS. 6A and 6B show an exemplary encryption and decryption scheme for NOR memory arrays in (FIG. 6A)) array level and (FIG. 6B) cell level.

The proposed encryption scheme can be implemented in the form of FeFET NOR array as well (shown in FIGS. 6A and 6B). Similar to the AND array case, 2 consecutive FeFETs in the same column are used to represent 1 bit encrypted information. During the encryption process, after the Key is XORed with PT to obtain the CT, the top and bottom FeFET are programmed to HVT (LVT) and LVT (HVT) respectively if CT=1 (0). While during the decryption process, the read voltage (V_{th,high}>V_{R}>V_{th,low}) is applied on the top (bottom) FeFET if Key=1(0). Only when V_{R} is applied on the LVT FeFET, a high current is sensed which represents PT=1. In this way, the XOR operation between Key and CT is realized in the NOR array.

### Programming and Inhibit Scheme

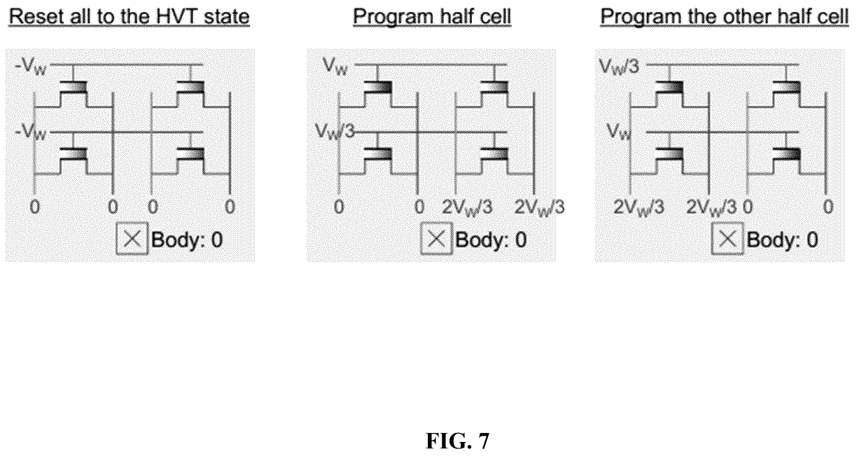

FIG. 7 shows exemplary three steps for programming of the FeFET AND array to implement an embodiment of the encryption scheme. Regarding the programming scheme, as shown in FIG. 7, we firstly program the whole block which need to be encrypted to HVT state by asserting all WLs at −VW (i.e., VW=3.3 V in this work), then program the complementary FeFET in each 2FeFET cell to LVT state by applying +VW on each WLs. Therefore, a total of 3 cycles are required to implement the encryption scheme. For proper operation of the array, inhibition bias schemes need to be applied to prevent undesired programming to unselected cells. Two schemes are generally available, i.e., VW/2 and VW/3 scheme. Here, we choose VW/3 scheme to minimize the disturb, as shown in FIG. 7.

Regarding the endurance of FeFETs used in arrays, though three programming cycles are required in encrypted FeFET cell, the programming is divided in the two FeFETs. Therefore, the number of writes is still the same as that in single FeFET array.

As can be appreciated from the present disclosure, an in-situ memory encryption/decryption scheme is provided which can guarantee high-level security by exploiting the intrinsic memory array operations while incurring negligible overheads. In addition, the functionality of the proposed scheme is verified through experiments on both device-level and array-level. Moreover, the evaluation results show that embodiments of the scheme can improve the encryption/decryption speed and throughput with negligible power cost from system-level aspect. Furthermore, an application-level case study is investigated. It shows that embodiments of the scheme can achieve 90% latency reduction on average compared to the prior AES-based accelerator.

### REFERENCES

The references listed below are incorporated herein by reference in their entireties.
1. Banerjee, W. Challenges and applications of emerging nonvolatile memory devices. Electronics 9, 1029 (2020).
2. Si, M., Cheng, H.-Y., Ando, T., Hu, G. & Ye, P. Overview and outlook of emerging non-volatile memories. MRS Bulletin 46 (2021).
3. Intel. Intel optane memory series.

https://ark.intel.com/content/www/us/en/ark/products/97544/intel-optane-memory-series--16gb-m-2-80mm-pcie-3-0-20nm-3d-xpoint.html.
4. Khan, M. N. I. & Ghosh, S. Comprehensive study of security and privacy of emerging non-volatile memories. Journal of Low Power Electronics and Applications 11 (2021). URL https://www.mdpi.eom/2079-9268/11/4/36.
5. Mittal, S. & Alsalibi, A. I. A survey of techniques for improving security of non-volatile memories. Journal of Hardware and Systems Security 2, 179-200 (2018).
6. Daemen, J. & Rijmen, V. Aes proposal: Rijndael (1999).
7. Gupta, A., Ahmad, A., Sharif, M. S. & Amira, A. Rapid prototyping of aes encryption for wireless communication system on fpga. In 2011 IEEE 15th International Symposium on Consumer Electronics (ISCE), 571-575 (2011).
8. Zhong, R., Zhang, Q., Zhao, Y. & Wu, C.-H. Research on enterprise financial accounting information security model based on big data. Wirel. Commun. Mob. Comput. 2022 (2022). URL https://doi.org/10.1155/2022/7929846.
9. Chhabra, S. & Solihin, Y. i-nvmm: A secure non-volatile main memory system with incremental encryption. In 2011 38th Anmial International Symposium on Computer Architecture (ISCA), 177-188 (2011).
10. Xie, M., Li, S., Glova, A. O., Hu, J. & Xie, Y. Securing emerging nonvolatile main memory with fast and energy-efficient aes in-memory implementation. IEEE Transactions on Very Large Scale Integration (VLSI) Systems 26, 2443-2455 (2018).
11. Chiu, Y.-C. et al. A 22 nm 4 mb stt-mram data-encrypted near-memory computation macro with a 192 gb/s read-and-decryption bandwidth and 25.1-55.1tops/w 8b mac for ai operations. In 2022 IEEE International Solid-State Circuits Conference (ISSCC), vol. 65, 178-180 (2022).
12. Cai, Y., Chen, X., Tian, L., Wang, Y. & Yang, H. Enabling secure nvm-based in-memory neural network computing by sparse fast gradient encryption. IEEE Transactions on Computers 69, 1596-1610 (2020).
13. Luo, J. et al. Novel ferroelectric tunnel finfet based encryption-embedded computing-in-memory for secure ai with high area-and energy-efficiency. In 2022 International Electron Devices Meeting (IEDM), 36.5.1-36.5.4 (2022).
14. Huang, S., Jiang, H., Peng, X., Li, W. & Yu, S. Secure xor-cim engine: Compute-in-memory sram architecture with embedded xor encryption. IEEE Transactions on Very Large Scale Integration (VLSI) Systems 29, 2027-2039 (2021).
15. AMD. Amd secure encrypted virtualization. https://www.amd.com/en/developer/sev.html.
16. Trentzsch, M. et al. A 28 nm hkmg super low power embedded nvm technology based on ferroelectric fets. In 2016 IEEE International Electron Devices Meeting (IEDM), 11.5.1-11.5.4 (2016).
17. Jiang, Z. et al. On the feasibility of It ferroelectric fet memory array. IEEE Transactions on Electron Devices 69, 6722-6730 (2022).
18. Shan, W., Fan, A., Xu, J., Yang, J. & Seok, M. A 923 gbps/w, 113-cycle, 2-sbox energy-efficient aes accelerator in 28 nm emos. In 2019 Symposium on VLSI Circuits, C236-C237 (2019).
19. Samajdar, A. et al. A systematic methodology for characterizing scalability of dnn accelerators using scale-sim. In 2020 IEEE International Symposium on Performance Analysis of Systems and Software (ISPASS), 58-68 (IEEE, 2020).

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the systems, compositions, materials, apparatuses, and methods of using and making the same disclosed herein have been discussed and illustrated, it is to be distinctly understood that the invention is not limited thereto but may be otherwise variously embodied and practiced within the scope of the following claims.

What is claimed is:

1. A system for configuring a data structure in a nonvolatile memory module, comprising:
a non-transitory memory having instructions stored thereon;
a processor configured to execute the instructions to perform an operation on a nonvolatile memory (NVM) module, wherein the NVM module includes at least one memory cell comprising two transistors coupled to each other such that a logic value is stored in a complementary manner, the operation including:
encrypting the at least one memory cell by generating a cipher text (CT) by performing an XOR operation on plain text (PT) stored in the at least one memory cell, and performing the XOR operation on a corresponding key; and/or
decrypting cipher text (CT) of the at least one memory cell by applying a read voltage pattern to the two transistors, the read voltage pattern being V_{R}/0 or 0/V_{R} based on a key.

2. The system of claim 1, wherein:
the two transistors coupled to each other are two consecutively situated transistors.

3. The system of claim 1, wherein:
the two transistors are field-effect-transistors (FETs).

4. The system of claim 3, wherein:
the FETs are FeFETs.

5. The system of claim 1, wherein:
the NVM module includes at least one memory block comprising plural memory cells.

6. The system of claim 5, wherein:
the NVM module includes plural memory blocks, and each memory cell within an individual memory block is associated with a key.

7. The system of claim 5, wherein:
the plural memory cells is arranged in an array.

8. The system of claim 7, wherein:
the plural memory cells is arranged as an AND array, a NAND array, or a NOR array.

9. The system of claim 1, wherein:
after decrypting cipher text (CT), the processor is configured to execute the instructions to generate plain text (PT) by sensing current when a signal representative of the key is applied to the at least one memory cell.

10. A computer readable memory having instruction stored thereon that when executed by a processor will cause the processor to:
execute the instructions to perform an operation on a nonvolatile memory (NVM) module, wherein the NVM module includes at least one memory cell comprising two transistors coupled to each other such that a logic value is stored in a complementary manner, the operation including:
encrypting the at least one memory cell by generating a cipher text (CT) by performing an XOR operation on plain text (PT) stored in the at least one memory cell, and performing the XOR operation on a corresponding key; and/or
decrypting cipher text (CT) of the at least one memory cell by applying a read voltage pattern to the two transistors, the read voltage pattern being V_{R}/0 or 0/V_{R} based on a key.

11. The system of claim 10, wherein:
the two transistors coupled to each other are two consecutively situated transistors.

12. The system of claim 10, wherein:
the two transistors are field-effect-transistors (FETs).

13. The system of claim 12, wherein:
the FETs are FeFETs.

14. The system of claim 10, wherein:
the NVM module includes at least one memory block comprising plural memory cells.

15. The system of claim 14, wherein:
the NVM module includes plural memory blocks, and each memory cell within an individual memory block is associated with a key.

16. The system of claim 14, wherein:
the plural memory cells is arranged in an array.

17. The system of claim 16, wherein:
the plural memory cells is arranged as an AND array, a NAND array, or a NOR array.

18. The system of claim 10, wherein:
after decrypting cipher text (CT), the processor is configured to execute the instructions to generate plain text (PT) by sensing current when a signal representative of the key is applied to the at least one memory cell.

19. A method for configuring a data structure in a nonvolatile memory (NVM) module, the NMV module including at least one memory cell comprising two transistors coupled to each other such that a logic value is stored in a complementary manner, the method comprising:
encrypting the at least one memory cell by generating a cipher text (CT) by performing an XOR operation on plain text (PT) stored in the at least one memory cell, and performing the XOR operation on a corresponding key; and/or
decrypting cipher text (CT) of the at least one memory cell by applying a read voltage pattern to the two transistors, the read voltage pattern being V_{R}/0 or 0/V_{R} based on a key.
